(19) United States
(12) Patent Application Publication
(10) Pub. No.: US 2002/0000377 A1
(43) Pub. Date: Jan. 3, 2002

(54) Oxygen sensor

(75) Inventor: Atsushi Matsuda, Gunma (JP)

Correspondence Address: Richard L. Schwaab, FOLEY & LARDNER, Washington Harbour, 3000 K Street, N.W., Suite 500, Washington, DC, 20007-5109, US

(73) Assignee: UNISIA JECS CORPORATION

(21) Appl. No.: 09/887,250

(22) Filed: Jun. 25, 2001

(30) Foreign Application Priority Data
Jun. 29, 2000 (JP) 2000-197056

(51) Int. Cl. G01N 27/407

(52) U.S. Cl. 204/426; 204/428

(57) ABSTRACT

An oxygen sensor including an elongated casing including an exhaust gas inlet through which the exhaust gas from a vehicle engine enters thereinto, a sensing element including an outer planar surface opposed to the exhaust gas inlet, and an inner planar surface on the opposite side of the outer planar surface, and a heater separably disposed on the inner planar surface of the sensing element.

### BACKGROUND OF THE INVENTION

The present invention relates to an oxygen sensor suitable for detecting oxygen concentration in an exhaust gas emitted from an engine of a vehicle.

Generally, when a vehicular engine with a turbo charger is operated at a rich side air-fuel ratio relative to a stoichiometric air-fuel ratio, a temperature of an exhaust gas emitted from the engine is approximately 280° C. Oxygen sensors are usually activated at approximately 350° C. The engine with the turbo charger, therefore, uses an oxygen sensor including a ceramic heater for heating the sensing element.

Japanese Patent Application First Publication No. 10-282050 discloses an oxygen sensor for detecting oxygen concentration in an exhaust gas emitted from a vehicular engine. The oxygen sensor includes a tubular casing, a sensing element disposed at an end of the casing, and a heater attached to the sensing element for heating the sensing element. The sensing element is made of ceramic materials such as zirconia, and provided with electrodes on the opposed surfaces. The electrodes are connected to a control unit via signal output terminals extending through the casing. The heater is connected to the control unit via electric energy supply terminals extending through the casing. The heater is fixed to the sensing element by sintering or adhering so that the heater and the sensing element form a laminated integral body. Hermetically sealed spaces are formed on both sides of the sensing element, one of which is opposed surfaces of the sensing element and the heater. The sensing element is activated to detect an electromotive force generated between the electrodes due to a difference between the oxygen concentration in the exhaust gas flowing into one of the hermetically sealed spaces and the oxygen concentration in the atmosphere flowing into the other of the hermetically sealed spaces. The sensing element transmits a signal output indicative of the electromotive force to the control unit. The control unit conducts a feedback control of air-fuel ratio depending on the signal output from the sensing element. If a temperature of the sensing element is low upon starting of the engine, the heater is operated by the control unit to heat the sensing element up to approximately 350° C. and bring the sensing element into the active state. As a result, the feedback control is earlier started.

Japanese Patent Application First Publication No. 9-26409 discloses an oxygen sensor including a zirconia-based sensing element, an alumina plate overlapping on the sensing element and a heater fixed to the alumina plate. The sensing element and the alumina plate are bonded to each other by sintering to form a laminated integral body.

In the above-described earlier techniques, the sensing element and the heater are bonded together by sintering or through an adhesive layer disposed therebetween. When the sensing element is heated by the heater, the heater tends to peel off from the sensing element due to the thermal stress caused therebetween upon heating. The peeling of the heater will cause damage, such as crack, to the sensing element.

Further, it is likely that the crack caused due to the peeling of the heater from the sensing element reaches the hermetically sealed space between the heater surface and the sensing element surface to thereby deteriorate air-tightness of the hermetically sealed space and reduce accuracy of detection of the oxygen concentration.

Furthermore, in the above-described earlier techniques, the production process of the oxygen sensor is complicated because the heater must be sintered or adhered to the sensing element for formation of the hermetically sealed space. Further, since the electrodes of the sensing element are embedded in the laminated body, two output terminals for external electrical-connection of the electrodes are required. This results in increase in the production cost.

In addition, if the laminated body is formed by sintering multiple ceramic layers different in composition, crack will occur during the sintering in the boundary between the ceramic layers due to a difference in thermal expansion therebetween.

### SUMMARY OF THE INVENTION

It is an object of the present invention to provide an oxygen sensor capable of being prevented from suffering from the thermal stress caused between the heater and the sensing element and from being damaged due to the thermal stress, and capable of being improved in its reliability and durability.

According to one aspect of the present invention, there is provided an oxygen sensor useable for sensing oxygen concentration in an exhaust gas, comprising:

an elongated casing including an exhaust gas inlet through which the exhaust gas enters thereinto;

a sensing element including first and second planar surfaces opposed to each other, the first planar surface being opposed to the exhaust gas inlet, and first and second electrodes disposed on the first and second planar surfaces, respectively, the sensing element being disposed within the casing; and

a heater separably disposed on the second planar surface of the sensing element.

According to a further aspect of the present invention, there is provided an oxygen sensor useable for sensing oxygen concentration in an exhaust gas, comprising:

an elongated casing including an exhaust gas inlet through which the exhaust gas enters thereinto;

a sensing element including first and second planar surfaces opposed to each other in a direction substantially crossing a longitudinal direction of the casing, the first planar surface being opposed to the exhaust gas inlet; and

a heater forced to be in contact with the second planar surface of the sensing element within the casing.

The other objects and features of this invention will become understood from the following description with reference to the accompanying drawings.

### BRIEF DESCRIPTION OF THE DRAWINGS

FIG. 1 is a longitudinal cross-section of an oxygen sensor of a first embodiment, according to the present invention;

FIG. 2 is an enlarged view of an important part of FIG. 1, showing an end portion of the oxygen sensor;

FIG. 3 is an exploded perspective view of the end portion of the oxygen sensor;

FIG. 4 is a diagram showing a relationship between a position on a heater surface and a temperature of the heater surface; and

FIG. 5 is a view similar to FIG. 2, but showing a second embodiment of the oxygen sensor.

### DETAILED DESCRIPTION OF THE INVENTION

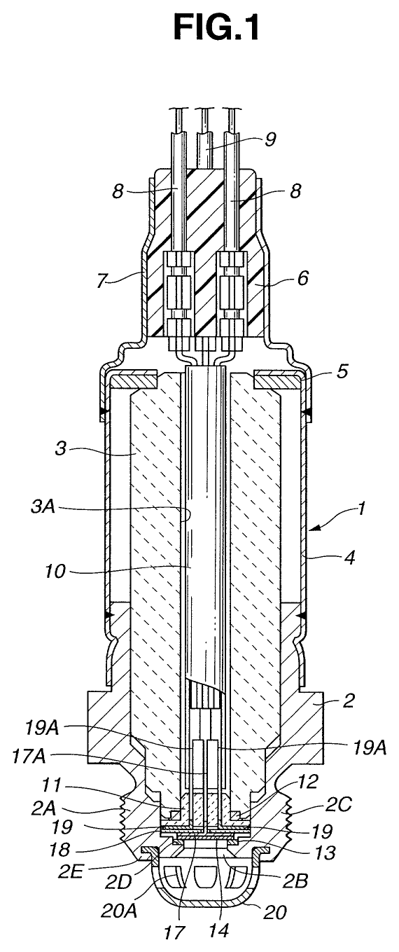

Referring now to FIGS. 1-4, an oxygen sensor, according to the present invention, of a first embodiment is explained. The oxygen sensor of this embodiment is applicable to engines of automobiles.

As illustrated in FIG. 1, the oxygen sensor includes an elongated cylindrical casing 1. The casing 1 is constituted of a stepped tube-shaped element holder 2, a tubular insulator 3 whose one end portion is received in the element holder 2, and a cylindrical cap 4 substantially enclosing the insulator 3. The element holder 2 is made of an electrically conductive metal material. The element holder 2 has an element-receiving portion 2A at one end thereof into which a sensing element 14 is mounted. The element holder 2 also has an exhaust gas inlet 2B located on a distal end of the element-receiving tube portion 2A. An exhaust gas emitted from the engine (not shown) is introduced to the sensing element 14 through the exhaust gas inlet 2B. A threaded portion 2C is formed on an outer circumferential surface. The oxygen sensor is mounted to an exhaust pipe (not shown) of the engine by screwing the threaded portion 2C into the exhaust pipe in such a manner that the sensing element 14 is exposed to the inside of the exhaust pipe. A positioning portion 2D is formed on an inner circumferential surface of the element-receiving portion 2A. The positioning portion 2D is formed by an annular recess around a center axis of the element holder 2. The positioning portion 2D is disposed adjacent to the exhaust gas inlet 2B in the axial direction of the element holder 2. The element holder 2 has a stepped inner periphery that is disposed axially adjacent to the positioning portion 2D and steppedly increased in diameter than the positioning portion 2D. A cover mount portion 2E is disposed on a radial outside of the exhaust gas inlet 2B, to which a protection cover 20 is mounted.

The insulator 3 is disposed in concentric with the element holder 2. As shown in FIG. 1, the insulator 3 has an axially extending bore 3A into which a tube 10 enclosing lead wires 8, 8 and 9 is inserted. The insulator 3 has a stepped outer periphery substantially corresponding to the stepped inner periphery of the element holder 2. The insulator 3 is made of a suitable ceramic material such as alumina.

The cap 4 has a cylindrical side wall extending along outer peripheral surfaces of the insulator 3 and the element holder 2, and an annular end wall that is connected with the side wall and opposed to an opposite end of the insulator 3. The cap 4 is fixed at one end thereof to a base portion of the element holder 2 by a suitable joining method such as welding, and extends in the axial direction of the insulator 3.

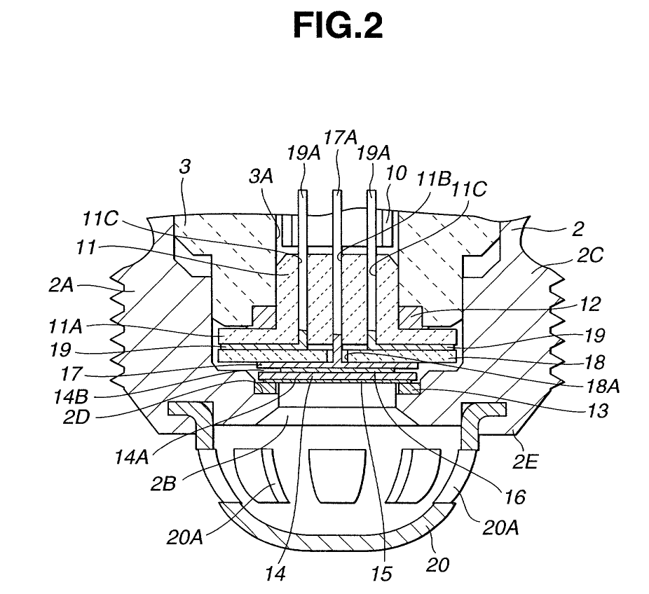

A disk spring 5 is installed inside the end wall of the cap 4 and interposed between the end wall of the cap 4 and the opposite end of the insulator 3. The disk spring 5 biases the insulator 3 toward the positioning portion 2D of the element holder 2 to retain the sensing element 14 and a heater 18 explained later at the positioning portion 2D. The cap 4 and the disk spring 5 cooperate to retain the sensing element 14 and the heater 18 between the opposite end of the insulator 3 and the positioning portion 2D of the element holder 2 as best shown in FIG. 2. The cap 4 holds the sensing element 14 and the heater 18 in place in the axial direction.

A tubular seal 6 is mounted to an axial end of the casing 1 through an outer cap 7 in such a manner as to be opposed to the opposite end of the insulator 3. The outer cap 7 is fixed to the side wall of the cap 4 near the end wall of the cap 4 by welding the outer periphery thereof (so-called welding-all-around). The tubular seal 6 is made of an insulating material and receives the lead wires 8, 8 for supplying electric energy to the heater 18 and the lead wire 9 for transmitting a signal output from the sensing element 14. Each of the lead wires 8 and 9 has one end extending from the casing 1 and the other end extending through the tube 10 toward the element-receiving portion 2A of the element holder 2. The lead wires 8, 8 are connected to a power source side of the automobile and an earth side thereof. The lead wire 9 is connected to a control unit (not shown) for controlling the engine of the automobile.

A generally cylindrical bushing 11 is concentrically mounted into the one axial end portion of the insulator 3. The bushing 11 is made of an insulating ceramic material and has a radially outwardly extending flange 11A shown in FIG. 2. A seal ring 12 is interposed between the flange 11A of the bushing 11 and the one axial end portion of the insulator 3. As shown in FIG. 2, the bushing 11 has a terminal-insertion through-hole 11B extending in a direction of a center axis of the bushing 11, into which a terminal 17A of an electrode plate 17 is inserted. Two terminal-insertion through-holes 11C, 11C extend substantially parallel to the terminal-insertion through-hole 11B, into which terminals 19A, 19A of a contact plate 19 are inserted.

As best shown in FIG. 2, a washer 13 is disposed on the positioning portion 2D of the element holder 2. The washer 13 is made of an electrically conductive metal material and has a generally annular shape. The sensing element 14, the electrode plate 17, the heater 18 and the contact plate 19 are disposed between the washer 13 and the bushing 11 within the element-receiving portion 2A of the element holder 2 and arranged in a laminated state.

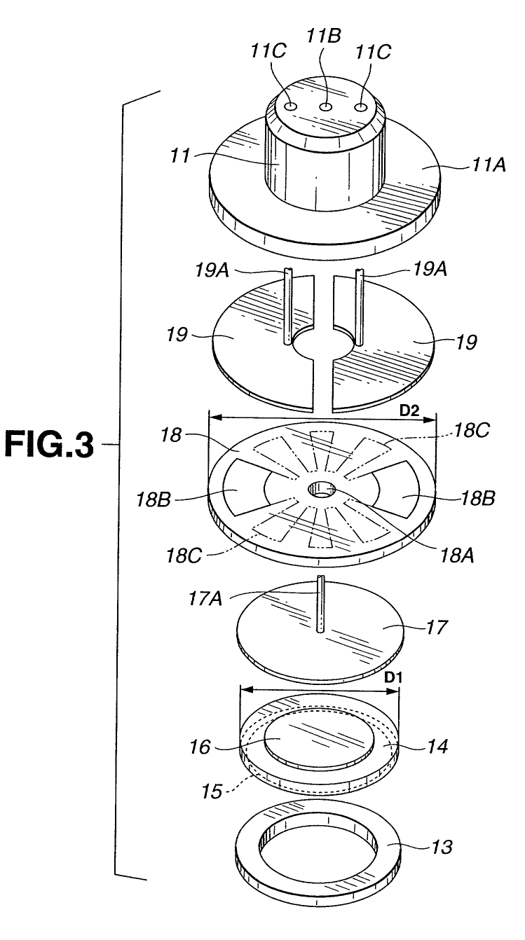

The sensing element 14 is mounted onto the washer 13 in such a manner that an outer planar surface 14A is opposed to the exhaust gas inlet 2B of the element holder 2 and thus exposed to the inside of the exhaust pipe of the engine. The sensing element 14 is made of a suitable ceramic material, zirconia in this embodiment. As shown in FIG. 3, the sensing element 14 has a generally thin disk shape having a diameter D1. The outer electrode 15 is disposed on the outer planar surface 14A of the sensing element 14 and an inner electrode 16 is disposed on an inner planar surface 14B of the sensing element 14. The sensing element 14 is operated to detect an electromotive force (voltage signal) generated between the outer and inner electrodes 15 and 16 in response to a difference between the oxygen concentration in the exhaust gas flowing on the outer planar surface 14A and the oxygen concentration in the atmosphere present on the inner planar surface 14B. The sensing element 14 then transmits a signal output indicative of the electromotive force to the control unit.

The outer and inner electrodes 15 and 16 are in the form of a generally circular thin film made of an electrically conductive paste containing platinum. The outer electrode 15 substantially covers the outer planar surface 14A of the sensing element 14. An outer circumferential portion of the outer electrode 15 is in contact with the washer 13 so that the outer electrode 15 is grounded to the exhaust pipe of the engine through the washer 13 and the element holder 2. The inner electrode 16 substantially covers the inner planar surface 14B of the sensing element 14. The inner electrode 16 is connected with the lead wire 9 through the electrode plate 17.

The electrode plate 17 is in the form of a generally disk shape made of an electrically conductive metal material. The electrode plate 17 is disposed on the sensing element 14 in contact with the inner electrode 16. As best shown in FIG. 2, the terminal 17A is connected to a central portion of the electrode plate 17 and extends into the tube 10 within the insulator 3 through a terminal-insertion through-hole 18A of the heater 18 and the through-hole 11B of the bushing 11. A distal end of the terminal 17A is connected with the lead wire 9 within the tube 10.

The heater 18 is arranged to be separably associated with the sensing element 14. Namely, the heater 18 is formed as a separate body from the sensing element 14 without being bonded thereto. The heater 18 is forced by the disk spring 5 against the inner planar surface 14B of the sensing element 14 to be in contact therewith through the electrode plate 17 interposed between the heater 18 and the sensing element 14. The heater 18 having a generally disk shape is disposed between the bushing 11 and the washer 13 in a concentric relation to the sensing element 14 and the electrode plate 17. The heater 18 has a diameter D2 larger than the diameter D1 of the sensing element 14 as shown in FIG. 3. The heater 18 has opposed planar surfaces each having an area greater than the area of each of the outer and inner planar surfaces 14A and 14B of the sensing element 14. The heater 18 covers the entire inner planar surface 14B of the sensing element 14. The heater 18 is formed of a burnt or fired ceramic material, such as burnt or fired alumina. As illustrated in FIG. 3, the heater 18 has a pair of diametrically opposed sector-shaped electrodes 18B, 18B on the planar surface facing the contact plate 19. Heater patterns 18C, 18C are embedded between the electrodes 18B, 18B. The heater patterns 18C, 18C extend over the sectorial areas between the electrodes 18B, 18B in a wavy or zigzag manner. The heater 18 is supplied with electric energy via the contact plate 19 to thereby heat the sensing element 14 through the electrode plate 17.

The contact plate 19 is interposed between the bushing 11 and the heater 18. The contact plate 19 is formed by a pair of the generally sector-shaped contact plates 19, 19 as shown in FIG. 3. The contact plates 19, 19 are arranged in contact with the electrodes 18B, 18B of the heater 18, respectively. Each of the contact plates 19, 19 is made of an electrically conductive metal material. The terminals 19A, 19A are connected to inner radial peripheries of the contact plates 19, 19, respectively. The terminals 19A, 19A extend into the tube 10 within the insulator 3 through the through-holes 11C, 11C of the bushing 11 as shown in FIG. 2. Distal ends of the terminals 19A, 19A are connected with the lead wires 8, 8 within the tube 10, respectively.

As best shown in FIG. 2, the domed protection cover 20 for protecting the sensing element 14 is caulked at the cover mount portion 2E of the element holder 2. The protection cover 20 is formed with a plurality of windows 20A circumferentially spaced from each other, through which the exhaust gas is introduced into the exhaust gas inlet 2B of the element holder 2.

An operation of the thus-constructed oxygen sensor now is explained.

When the exhaust gas emitted from the engine during the engine operation passes through the exhaust pipe and enters into the exhaust gas inlet 2B of the element holder 2 of the oxygen sensor, the sensing element 14 is activated to detect an electromotive force generated between the outer and inner electrodes 15 and 16 due to a difference between the oxygen concentration in the exhaust gas present on the outer planar surface 14A side and the oxygen concentration in the atmosphere present on the inner planar surface 14B side. The sensing element 14 transmits a signal output indicative of the electromotive force to the control unit via the electrode plate 17 and the lead wire 9. The control unit carries out a feedback control of air-fuel ratio on the basis of the signal output transmitted. If the temperature of the sensing element 14 is lower than a level sufficient to activate the sensing element 14 upon the engine starting, the control unit operates the heater 18 so as to be supplied with electric energy via the lead wires 8, 8 and the contact plates 19, 19. The heater 18 is thus actuated to heat the electrode plate 17 and the sensing element 14. When the sensing element 14 is heated up to a predetermined temperature, for instance, approximately 350° C., the sensing element 14 is activated. The activation of the sensing element 14 is facilitated by the heating by the heater 18, so that the feedback control of air-fuel ratio can be early commenced.

As is appreciated from the above explanation, the sensing element 14 and the heater 18 are separably associated with each other, i.e., formed as the separate bodies from each other. With the arrangement, one of the sensing element 14 and the heater 18 can be prevented from suffering from thermal stress caused on the other during the heating because the two elements can be separately expanded and shrunk. The sensing element 14 and the heater 18 can be prevented from being damaged due to the peeling of the heater 18 which will occur during the heating in the oxygen sensors of the earlier techniques. This can enhance reliability and durability of the oxygen sensor. In addition, the sintering and/or adhering process for bonding the sensing element and the heater together as proposed in the earlier techniques can be omitted. This can avoid the occurrence of cracks in the sintering process and serve for improving the production efficiency and reducing the production cost.

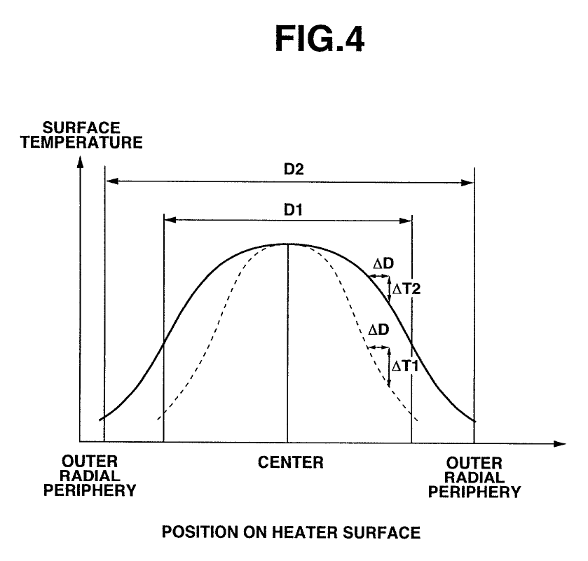

Further, as described above, the sensing element 14 is arranged in concentric with the heater 18 having the greater surface area than that of the sensing element 14. This arrangement can provide good temperature distribution on the planar surface of the heater 18 as shown in FIG. 4, serving for reducing the thermal stress acting on the heater 18.

In FIG. 4, a characteristic curve of the temperature distribution on the planar surface of the heater 18 is indicated by the solid line. The broken line indicates a characteristic curve of the temperature distribution on the heater surface in a case where the planar surface of the heater 18 has the same area as that of the planar surface of the sensing element 14. In other words, the broken line denotes the characteristic curve of the temperature distribution on the heater surface when the diameter of the heater 18 is equivalent to the diameter D1 of the sensing element 14. As illustrated in FIG. 4, the temperature at the central portion, namely, the inner radial periphery near around the terminal-insertion through-hole 18A, of the heater surface is higher than the temperature at the outer radial periphery thereof. Temperature gradient of the heater surface is expressed by a temperature change ΔT1 and ΔT2 of the heater surface relative to a radial position change ΔD on the heater surface. The temperature gradient ΔT2/ΔD of the heater surface having the greater area than the area of the planar surface of the sensing element 14 is smaller than the temperature gradient ΔT1/ΔD of the heater surface having the same area as the area of the planar surface of the sensing element 14. Therefore, if the heater 18 having a relatively greater surface area is used, the temperature gradient of the heater surface can be lowered and the thermal stress acting on the heater 18 corresponding to the temperature gradient of the heater surface can be reduced. The heater 18 having such the greater surface area can be prevented from being damaged due to the thermal stress. This results in improving the oxygen sensor in the reliability and durability.

Further, the heater 18 can substantially evenly heat the sensing element 14 over the entire area thereof. In addition, the heater 18 can be heated at higher temperature to thereby heat the sensing element 14 more quickly. The sensing element 14 can be activated within a shorter period during the engine starting operation, so that the detection of the oxygen concentration can be promoted.

Furthermore, as explained above, the washer 13 is located between the sensing element 14 and the element holder 2, and the electrode plate 17 is interposed between the sensing element 14 and the heater 18. The sensing element 14 is grounded through the washer 13 and the element holder 2 and permitted to transmit the signal output to the control unit through the electrode plate 17. With this arrangement, the single lead wire 9 for transmitting the signal output can be connected with the electrode plate 17, and another,output terminal or lead wire as used in the earlier technique can be omitted. This can simplify the structure of the oxygen sensor, serving for the cost-saving.

Further, the casing 1 is constituted of the element holder 2 having the positioning portion 2D, the insulator 3 received in the element holder 2, and the cap 4 securing the insulator 3 to the element holder 2. The element holder 2, the insulator 3 and the cap 4 cooperate to support the sensing element 14 and the heater 18 between the positioning portion 2D and the axial end portion of the insulator 3. Furthermore, the disk spring 5 is installed into the cap 4 and biases the insulator 3 toward the positioning portion 2D to force the sensing element 14 and the heater 18 against the positioning portion 2D. With this arrangement, the sensing element 14 and the heater 18 which are separably overlapped, can be held in place within the element-receiving portion 2A of the element holder 2 without displacement. In addition, the spring force of the disk spring 5 acts onto the outer and inner planar surfaces 14A and 14B of the sensing element 14, so that the electrodes 15 and 16 can be kept in contact with the washer 13 and the electrode plate 17, respectively. This can assure transmission of the signal output from the sensing element 14. In addition, the electrodes 18B, 18B of the heater 18 can be kept in contact with the contact plates 19, 19 by the spring force of the disk spring 5. Therefore, the electric energy supply to the heater 18 through the contact plates 19, 19 can be stably conducted.

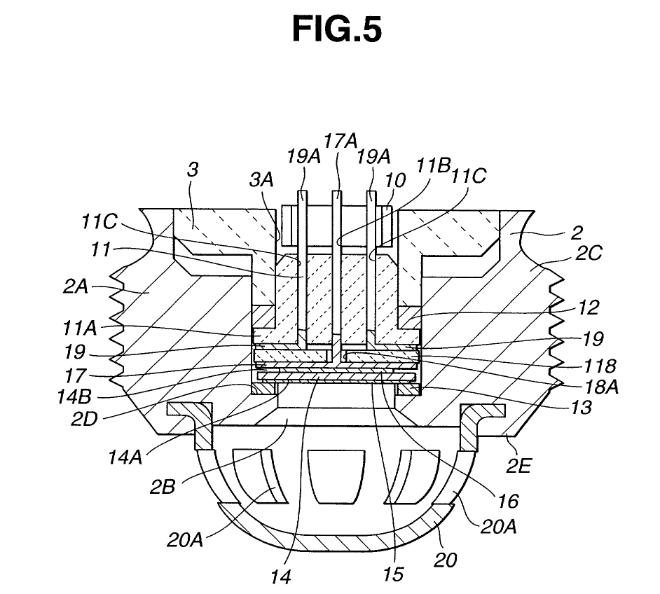

Referring to FIG. 5, a second embodiment of the oxygen sensor of the invention will be explained hereinafter, which differs in arrangement of the heater 118 from the above-described first embodiment. Like reference numerals denote like parts, and therefore, detailed explanations therefor can be omitted.

As illustrated in FIG. 5, the heater 118 has substantially the same diameter as that of the sensing element 14. Namely, the area of the planar surface of the heater 118 is substantially the same as the area of the planar surface of the sensing element 14.

The second embodiment can perform substantially the same effects as those of the first embodiment. Namely, since the heater 118 and the sensing element 14 are separably arranged, the thermal stress caused between the heater 118 and the sensing element 14 can be reduced. The heater 118 and the sensing element 14 can be prevented from being adversely affected by the thermal stress. This can contribute to improvement in the reliability and durability of the oxygen sensor and in the production efficiency and to reduction of the production cost. Further, since the electrode plate 17 is connected with the single lead wire 9, the second embodiment can provide the simple structure of the oxygen sensor and contribute to the are cost-saving. Furthermore, the heater 118 and the sensing element 14 can be held in place and surely retained within the element-receiving portion 2A of the element holder 2.

The entire contents of basic Japanese Patent Application No. 2000-197056 filed on Jun. 29, 2000, inclusive of the specification, claims and drawings, are herein incorporated by reference.

Although the invention has been described above by reference to certain embodiments of the invention, the invention is not limited to the embodiments described above. Modifications and variations of the embodiment described above will occur to those skilled in the art, in light of the above teachings. The scope of the invention is defined with reference to the following claims.

What is claimed is:

1. An oxygen sensor useable for sensing oxygen concentration in an exhaust gas, comprising:
an elongated casing including an exhaust gas inlet through which the exhaust gas enters thereinto;
a sensing element including first and second planar surfaces opposed to each other, the first planar surface being opposed to the exhaust gas inlet, and first and second electrodes disposed on the first and second planar surfaces, respectively, the sensing element being disposed within the casing; and
a heater separably disposed on the second planar surface of the sensing element.

2. The oxygen sensor as claimed in claim 1, wherein the heater has an area larger than the second planar surface of the sensing element, the heater extending over the entire second planar surface of the sensing element.

3. The oxygen sensor as claimed in claim 1, further comprising an electrically conductive washer disposed between the sensing element and the casing in contact with the first electrode.

4. The oxygen sensor as claimed in claim 1, further comprising an electrically conductive electrode plate disposed between the sensing element and the heater in contact with the second electrode.

5. The oxygen sensor as claimed in claim 4, wherein the casing comprises an element holder formed with a recess receiving the sensing element and the heater, an insulator including one end mounted into the element holder, and a cap extending over an outer periphery of the insulator and holding the insulator in place relative to the element holder.

6. The oxygen sensor as claimed in claim 5, further comprising a disk spring biasing the insulator against the recess of the element holder to retain the sensing element at the recess, the disk spring being mounted into the cap.

7. The oxygen sensor as claimed in claim 5, further comprising lead wires separately electrically connected with the sensing element and the heater, the lead wires extending through the insulator.

8. The oxygen sensor as claimed in claim 7, wherein one of the lead wires is electrically connected with the electrode plate.

9. The oxygen sensor as claimed in claim 7, further comprising a contact plate disposed on the heater in contact therewith, one of the lead wires being electrically connected with the contact plate.

10. The oxygen sensor as claimed in claim 9, wherein the contact plate comprises a pair of contact plates.

11. The oxygen sensor as claimed in claim 1, wherein the first and second planar surfaces of the sensing element extend in a direction substantially crossing a longitudinal direction of the casing.

12. The oxygen sensor as claimed in claim 1, wherein the heater has an area substantially same as the second planar surface of the sensing element, the heater extending over the entire second planar surface of the sensing element.

13. An oxygen sensor useable for sensing oxygen concentration in an exhaust gas, comprising:
an elongated casing including an exhaust gas inlet through which the exhaust gas enters thereinto;
a sensing element including first and second planar surfaces opposed to each other in a direction substantially crossing a longitudinal direction of the casing, the first planar surface being opposed to the exhaust gas inlet; and
a heater forced to be in contact with the second planar surface of the sensing element within the casing.

14. The oxygen sensor as claimed in claim 13, further comprising a disk spring biasing the heater against the second planar surface of the sensing element.

15. The oxygen sensor as claimed in claim 13, wherein the heater has an area larger than the second planar surface of the sensing element, the heater extending over the entire second planer surface of the sensing element.

16. The oxygen sensor as claimed in claim 13, further comprising an electrically conductive electrode plate interposed between the heater and the second planer surface of the sensing element.

17. The oxygen sensor as claimed in claim 16, wherein the sensing element comprises a first electrode disposed on the first planar surface and a second electrode disposed on the second planar surface, the second electrode being in contact with the electrode plate.

18. The oxygen sensor as claimed in claim 14, wherein the casing is formed with a positioning portion against which the sensing element is forced together with the heater.

19. The oxygen sensor as claimed in claim 18, wherein the casing comprises an element holder formed with the positioning portion, an insulator including one end mounted into the element holder and opposed to the positioning portion, and a cap extending toward an opposite end of the insulator along outer peripheries of the insulator and the element holder, the disk spring being installed between the opposite end of the insulator and the cap.

20. The oxygen sensor as claimed in claim 13, further comprising a contact plate disposed on the heater in contact therewith.

21. The oxygen sensor as claimed in claim 20, further comprising a first lead wire electrically connected with the electrode plate and a second lead wire electrically connected with the contact plate.

22. The oxygen sensor as claimed in claim 13, wherein the heater has an area substantially same as the second planar surface of the sensing element, the heater extending over the entire second planar surface of the sensing element.
